(19) United States
(12) Patent Application Publication
(10) Pub. No.: US 2005/0159050 A1
(43) Pub. Date: Jul. 21, 2005

(54) Device interface apparatus

(76) Inventors: Hiroyuki Hama, Tokyo (JP); Shigeru Matsumura, Tokyo (JP)

Correspondence Address: MURAMATSU & ASSOCIATES, Suite 225, 7700 Irvine Center Drive, Irvine, CA, 92618, US

(21) Appl. No.: 11/003,695

(22) Filed: Dec. 3, 2004

Related U.S. Application Data
(63) Continuation of application No. PCT/JP04/07526, filed on Jun. 1, 2004.

(30) Foreign Application Priority Data
Jun. 5, 2003 (JP) JP 2003-161064

(51) Int. Cl. H01R 25/00

(52) U.S. Cl. 439/651

(57) ABSTRACT

A device interface apparatus for providing a device under test with a test signal to test the device under test and receiving an output signal outputted from the device under test includes a pin electronics board, a board-side connector provided on an end section of the pin electronics board, wherein the board-side connector includes a plurality of board-side core wires and a board-side shield, a socket for holding the device under test, a socket-side connector including a plurality of socket-side core wires and a socket-side shield, and a cable unit for transmitting the transmission signal between the socket and the pin electronics board, wherein the cable unit includes a board fitting connector, a socket fitting connector, and a plurality of transmission cables.

The present application is a continuation application of PCT/JP2004/7526 filed on Jun. 1, 2004 which claims the benefit of, and priority from, Japanese patent application No. 2003-161064 filed on Jun. 5, 2003, the entire contents of which are incorporated herein by reference for all purposes.

### FIELD OF THE INVENTION

The present invention relates to a device interface apparatus. More particularly, the present invention relates to a device interface apparatus for providing a device under test with a test signal for the test of the device under test and receiving the output signal outputted from the device under test.

### RELATED ART

A test apparatus for testing an electronic device judges the pass or fail of the electronic device by comparing the output signal of the electronic device with an expected signal. The test apparatus inputs or outputs the signal from or to the electronic device using a pin electronics board provided in a test head.

As the operation speed of the electronic device recently increases, it is also required to increase the speed of the test apparatus. However, the test apparatus performing the test at a high speed often costs too much because it requires high precision. Accordingly, in the prior art, there is a problem that the test cost of the electronic device increases due to the cost of the test apparatus. Therefore, it has been difficult to reduce the cost of the electronic device.

### SUMMARY OF THE INVENTION

Accordingly, it is an object of the present invention to provide a device interface apparatus, which is capable of overcoming the above drawbacks accompanying the conventional art. The above and other objects can be achieved by combinations described in the independent claims. The dependent claims define further advantageous and exemplary combinations of the present invention.

In order to solve the problems above, according to the first aspect of the present invention, a device interface apparatus for providing a device under test with a test signal to test the device under test and receiving an output signal outputted from the device under test includes a pin electronics board including a driver for outputting the test signal and a comparator for sampling the output signal, a board-side connector provided on an end section of the pin electronics board, wherein the board-side connector includes a board-side core wire for transmitting a transmission signal, which is at least either the test signal or the output signal, and a board-side shield surrounding the board-side core wire, a socket contacting a terminal of the device under test for holding the device under test, a socket-side connector provided on the socket, wherein the socket-side connector includes a socket-side core wire for sending or receiving the transmission signal to or from the device under test via the socket and a socket-side shield surrounding the socket-side core wire, and a cable unit for transmitting the transmission signal between the socket and the pin electronics board, wherein the cable unit includes a board fitting connector fitted with the board-side connector, a socket fitting connector fitted with the socket-side connector and a transmission cable for transmitting the transmission signal between the board fitting connector and the socket fitting connector, and the transmission cable includes a transmission line for transmitting the transmission signal between the board-side core wire and the socket-side core wire by electrically coupling the board-side core wire and the socket-side core wire and a cable shield electrically coupled to the board-side shield and the socket-side shield and surrounding the transmission line.

The board-side connector may include a plurality of the board-side core wires and the board-side shield surrounding each of the plurality of board-side core wires, the socket contacts each of the terminals of the device under test and holds the device under test, the socket-side connector includes a plurality of the socket-side core wires and the socket-side shield surrounding each of the plurality of socket-side core wires, and the cable unit includes a plurality of the transmission cables.

The device interface apparatus may further include a connector holding unit for holding the socket fitting connector on a predetermined position, so that the socket fitting connector faces the socket, wherein the socket-side connector may be fitted with the socket fitting connector on the predetermined position.

The device interface apparatus may further include a motherboard unit including the cable unit and the connector holding unit and a detachable unit including the socket and the socket-side connector, wherein the detachable unit can be mechanically attached or detached to or from the motherboard unit according to whether the socket-side connector and the socket fitting connector are fitted with each other or not.

The detachable unit may be formed corresponding to a product type of the device under test and attached to the motherboard unit when the device under test of a corresponding product type is tested.

The device interface apparatus may further include a test head including the pin electronics board and the board-side connector, wherein the motherboard unit may be mechanically attached or detached to or from the test head according to whether the board-side connector and the board fitting connector are fitted with each other or not.

The board-side connector may include a plurality of the board-side shields respectively surrounding each of the plurality of board-side core wires and electrically independent from one another in the board-side connector, and the cable shields of the plurality of transmission cables may be independent from one another between the board fitting connector and the socket fitting connector and respectively electrically coupled to each of the plurality of board-side shields.

The board fitting connector may include a plurality of transmission core wires respectively coupled to each of the transmission lines of the plurality of transmission cables and a plurality of transmission shields respectively surrounding each of the plurality of transmission core wires, electrically independent from one another in the board fitting connector, and respectively coupling each of the plurality of cable shields and each of the plurality of board-side shields.

The pin electronics board may include a signal wire for transmitting the transmission signal and a plurality of ground wires which are grounded, the board-side core wire formed of a conductor may extend linearly, the board-side shield may be formed of a conductor electrically insulated from the board-side core wire, extending in an axis direction of the board-side core wire and surrounding the board-side core wire, and the board-side connector may further include a signal electrode extending from the board-side core wire and electrically coupling the board-side core wire and the signal wire and a plurality of ground electrodes extending from the board-side shield, facing each other with the signal electrode interposed, and coupling the board-side shield and each of the plurality of ground wires.

The socket-side connector may include a plurality of the socket-side shields respectively surrounding each of the plurality of socket-side core wires and electrically independent from one another in the socket-side connector, and the cable shields of the plurality of transmission cables may be electrically independent from one another between the board fitting connector and the socket fitting connector and respectively electrically coupled to each of the plurality of socket-side shields.

The socket fitting connector may include a plurality of transmission core wires respectively coupled to the transmission line of each of the plurality of transmission cables and a plurality of transmission shields respectively surrounding each of the plurality of transmission core wires, electrically independent from one another in the socket fitting connector, and respectively coupling each of the plurality of cable shields and each of the plurality of socket-side shields.

The socket may include a signal wire for transmitting the transmission signal and a plurality of ground wires which are grounded, the socket-side core wire formed of a conductor may extend linearly, the socket-side shield may be formed of a conductor electrically insulated from the socket-side core wire, extending in an axis direction of the socket-side core wire and surrounding the socket-side core wire, and the socket-side connector may further include a signal electrode extending from the socket-side core wire and electrically coupling the socket-side core wire and the signal wire and a plurality of ground electrodes extending from the socket-side shield, facing each other with the signal electrode interposed, and coupling the socket-side shield and each of the plurality of ground wires.

The board fitting connector may include a transmission core wire coupled to the transmission line of the transmission cable and a transmission shield surrounding the transmission core wire in the socket fitting connector and coupling the cable shield and the board-side shield, and the board-side shield may contact the transmission shield before the board-side core wire is coupled to the transmission core wire, when the board-side connector and the board fitting connector are coupled to each other.

The socket fitting connector may include a transmission core wire coupled to the transmission line of the transmission cable and a transmission shield surrounding the transmission core wire in the socket fitting connector and coupling the cable shield and the board-side shield, and the socket-side shield may contact the transmission shield before the board-side core wire is coupled to the transmission core wire, when the socket-side connector and the socket fitting connector are coupled to each other.

The summary of the invention does not necessarily describe all necessary features of the present invention. The present invention may also be a sub-combination of the features described above.

### BRIEF DESCRIPTION OF DRAWINGS

FIG. 1 shows an example the configuration of a test apparatus 500 according to an exemplary embodiment of the present invention.

FIG. 2 shows an example of the detailed configuration of a device interface unit 510.

FIG. 3 shows a perspective view of a common motherboard 506 and a product type corresponding unit 508.

FIG. 4 shows a method of coupling a product type corresponding unit 508, a test head 504, and a common motherboard 506.

FIG. 5 shows an example of the detailed configuration of a connector 710, a connector 702, and a cable unit 708.

FIG. 6 shows an example of the configuration of a test module 604.

FIG. 7 shows the configuration of a plug connector 100.

FIG. 8 shows an example of the detailed configuration of a plug signal terminal 10.

FIG. 9 shows an example of the detailed configuration of a plug core wire shield 14 and plug ground electrodes 18.

FIG. 10 shows an example of the detailed configuration of a plug-side board 200.

FIG. 11 shows the B-B sectional view of a plug connector 100.

FIG. 12 shows the configuration of a receptacle connector 300.

FIG. 13 shows an example of the detailed configuration of a receptacle connector 300.

FIG. 14 shows an example of the detailed configuration of a receptacle signal core wire 22 and a receptacle core wire shield 24.

FIG. 15 shows an example of the detailed configuration of a receptacle-side housing 60.

FIG. 16 shows another example of the configuration of the receptacle connector 300.

FIG. 17 shows the sectional view of a plug signal terminal 10 and a receptacle signal terminal 20 fitted with each other.

FIG. 18 shows another example of the configuration of the plug signal terminal 30.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

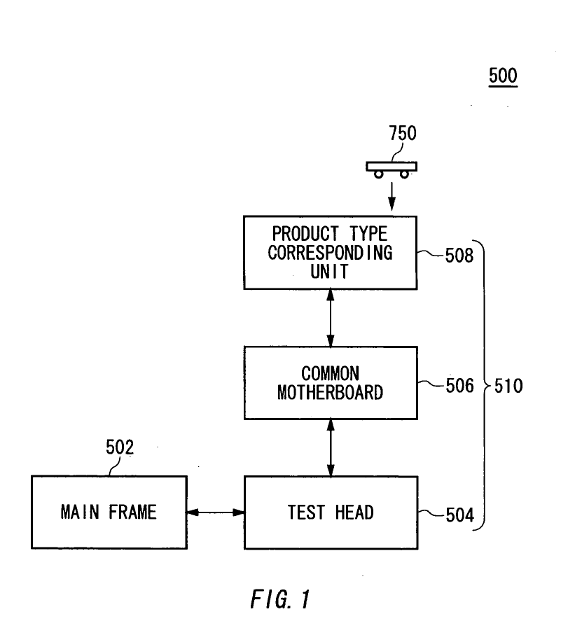

FIG. 1 shows an example the configuration of a test apparatus 500 according to an exemplary embodiment of the present invention. An object of this invention is to provide a test apparatus for precisely inputting and outputting a signal to/from a device under test 750 at a high speed and a low cost. The test apparatus 500 includes a device interface unit 510 and a main frame 502. The device interface unit 510 includes a test head 504, a common motherboard 506, and a product type corresponding unit 508.

The test head 504 generates a test signal for the test of the device under test 750 in response to the instruction of the main frame 502 and outputs it to the common motherboard 506. Moreover, the test head 504 receives the output signal of the device under test 750 via the common motherboard 506. The test head 504 detects the value of the output signal and provides it to the main frame 502. Further, the device under test 750 is an electronic device under test (DUT).

The common motherboard 506 is a part of a motherboard unit, supplying the product type corresponding unit 508 with the test signal received from the test head 504. Moreover, the common motherboard 506 receives the output signal of the device under test 750 via the product type corresponding unit 508 and supplies it to the test head 504. In this embodiment, the common motherboard 506 of the test apparatus 500 is used in common for a plurality of types of devices under test 750.

The device under test 750 is mounted and fixed on the product type corresponding unit 508. Moreover, the product type corresponding unit 508 supplies the test signal received from the common motherboard 506 to the device under test 750. Moreover, the product type corresponding unit 508 receives the output signal of the device under test 750 and supplies it to the common motherboard 506. Accordingly, the device interface unit 510 fixes the device under test 750 and inputs or outputs the signal from or to the device under test 750.

Further in this embodiment, the product type corresponding unit 508 is formed, replaced and used corresponding to the product type of the device under test 750. When the device under test 750 is tested, the product type corresponding unit 508, which corresponds to the product type of the device under test 750, may be attached to the common motherboard 506. Moreover, the product type corresponding unit 508 is an example of a detachable unit. In this embodiment, by replacing the product type corresponding unit 508, it is possible to test a number of product types of devices under test 750.

For example, the main frame 502 is a workstation, which allows the test head 504 to output the test signal by sending a control signal to the test head 504. Moreover, the main frame 502 judges the pass or fail of the device under test 750 by receiving the value of the output signal of the device under test 750 from the test head 504 and comparing it with an expected value. Accordingly, the main frame 502 manages the test of the device under test 750. According to this embodiment, it is possible to properly perform the test of the device under test 750. Further in this embodiment, the test head 504 may judge the pass or fail of the device under test 750. In this case, the main frame 502 may receive the judgment result about the pass or fail from the test head 504.

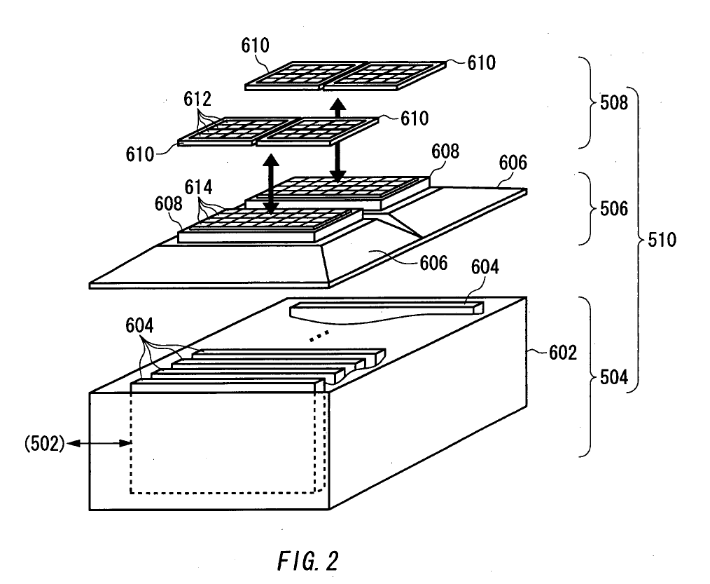

FIG. 2 shows an example of the detailed configuration of the device interface unit 510. In this embodiment, the test head 50.4 includes an enclosure 602 and a plurality of test modules 604. The enclosure 602 is a frame formed of metal, containing and holding the plurality of test modules 604 therein.

The plurality of test modules 604 are detachably held inside the enclosure 602. In this embodiment, the test module 604 is a pin electronics board, generating the test signal to be provided to the device under test 750 (see FIG. 1) in response to the instruction of the main frame 502 and outputting the test signal to the common motherboard 506. Moreover, the test module 604 receives the output signal of the device under test 750 from the common motherboard 506 and detects its value. The test module 604 may supply the value detected to the main frame 502.

Further in another embodiment, a part of the plurality of test modules 604 may have the function of a pattern generator. In this case, the test module 604 having the function of the pin electronics board may output the test signal in response to the signal received from the test modules 604 having the function of the pattern generator.

The common motherboard 506 includes a plurality of connector holding units 608, a plurality of connectors 614, and a plurality of holding bases 606. Each of the plurality of connector holding units 608 is mounted on an upper face of the holding base 606, fixing and holding the plurality of connectors 614. The plurality of connectors 614 are electrically coupled to the product type corresponding unit 508, when the product type corresponding unit 508 and the common motherboard 506 are coupled to each other.

The plurality of holding bases 606 are mounted on the test head 504, electrically coupled to the plurality of test modules 604 on their bottom faces. Moreover, the connector holding units 608 are mounted and fixed on upper faces of the holding bases 606. In this case, the holding bases 606 are electrically coupled to the plurality of connectors 614. Accordingly, when the common motherboard 506 and the test head 504 are coupled to each other, the holding bases 606 electrically couple the plurality of test modules 604 and the plurality of connectors 614. Accordingly, the common motherboard 506 electrically couples the test head 504 and the product type corresponding unit 508.

The product type corresponding unit 508 includes a plurality of sockets 612 and a plurality of socket holding units 610. Each of the plurality of sockets 612 holds the device under test 750. Moreover, the socket 612 is electrically coupled to the connector 614, so that the connector 614 and the device under test 750 are electrically coupled to each other.

Each of the plurality of socket holding units 610 fixes and holds the plurality of sockets 612. Moreover, the socket holding unit 610 is mounted on the connector holding unit 608 so as to couple the plurality of sockets 612 and the plurality of connectors 614.

According to this embodiment, it is possible to properly couple the device under test 750 and the test head 504. The device interface unit 510 may send the test signal to the device under test 750 as well as receiving the output signal outputted from the device under test 750. According to this embodiment, it is possible to properly test the device under test 750.

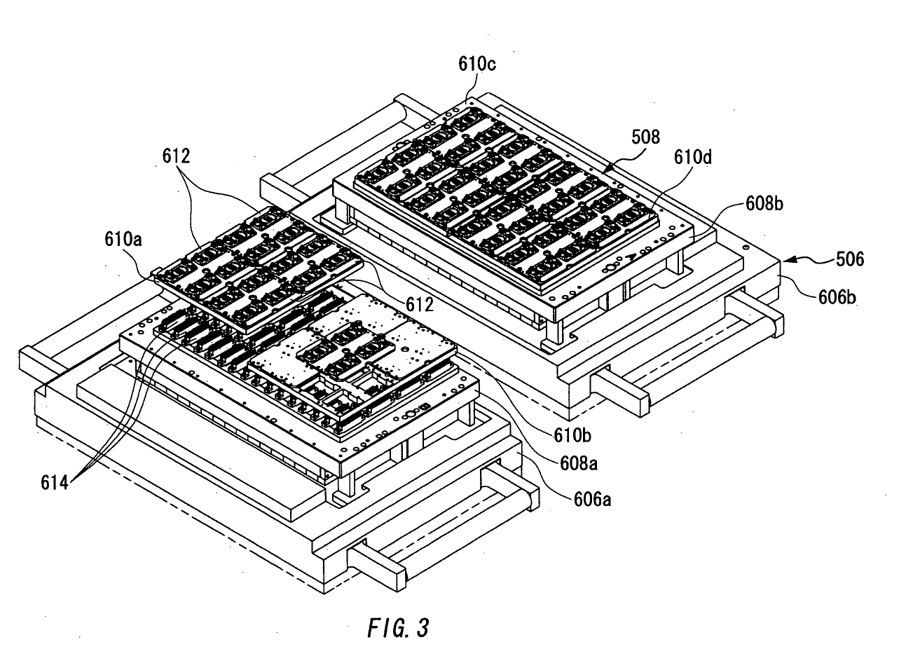

FIG. 3 shows a perspective view of the common motherboard 506 and the product type corresponding unit 508. In this embodiment, the common motherboard 506 is divided into two parts, including two holding bases 606a and 606b and two connector holding units 608a and 608b. Accordingly, since the weight of a holding base 606 and a connector holding unit 608 is light, the operability of the common motherboard 506 can be improved. Moreover, in this embodiment, the connector holding units 608 hold the plurality of connectors 614 so that they can be arranged at predetermined positions to face the sockets 612, e.g. in the form of rows.

The product type corresponding unit 508 includes four socket holding units 610a, 610b, 610c and 610d. Two socket holding units 610a and 610b are mounted on the connector holding unit 608a and the other two socket holding units 610c and 610d are mounted on the connector holding unit 608b.

The socket holding units 610 hold the plurality of sockets 612. Each of the socket holding units 610 may hold the different number of sockets 612, e.g. the socket holding unit 610a and the socket holding unit 610b.

In this embodiment, the socket holding units 610 hold the plurality of sockets 612 at the positions facing the plurality of connectors 614. In this case, by determining the positions of the sockets 612 in advance corresponding to the positions of the connectors 614, it is possible to use the common motherboard 506 in common even if the terminal arrangement of the device under test 750 (see FIG. 1) changes corresponding to the product type.

Further, as the recent applications vary, the type of the electronic device varies. If the coupling formation of the test head 504 and the device under test 750 should be changed according to the product type of the device under test 750, the test cost of the device under test 750 increases. According to this embodiment, however, by replacing the product type corresponding unit 508 corresponding to the product type of the device under test 750 in testing a plurality of types of devices under test 750, the cost of the test apparatus 500 can be reduced. Accordingly, it is possible to reduce the cost of the device under test 750.

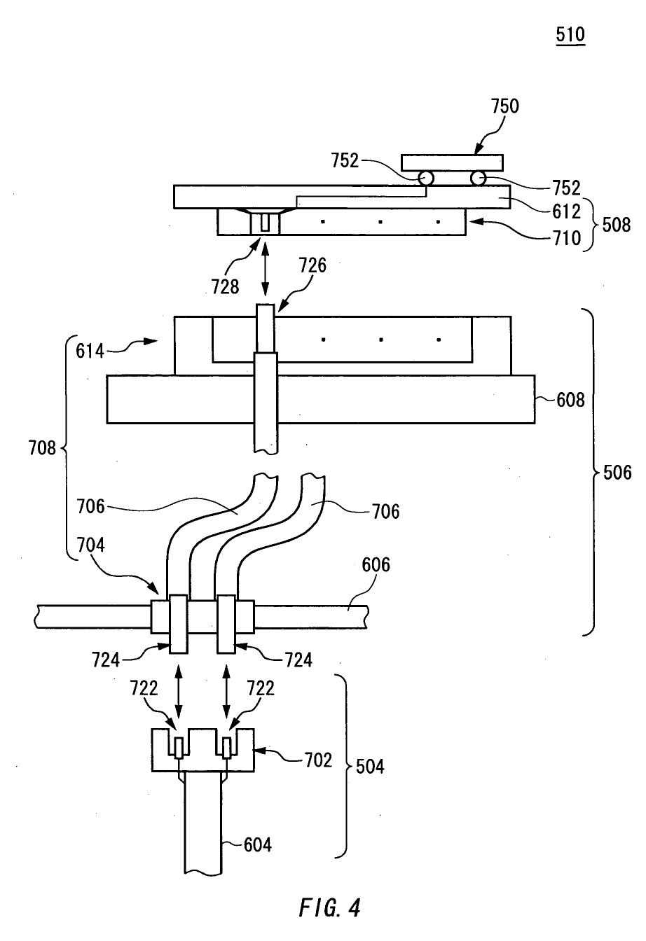

FIG. 4 shows a method of coupling the product type corresponding unit 508, the test head 504, and the common motherboard 506. Further, except the matters described below, the components in FIG. 4 bearing the same reference numerals as those in FIG. 2 or 3 have the same functions as those in FIG. 2 or 3. Therefore, the explanation about these components will be omitted.

In this embodiment, the product type corresponding unit 508 includes a socket holding unit 610 (see FIG. 2), a socket 612, and a connector 710. The socket 612 holds the device under test 750, contacting each terminal 752 of the device under test 750. Moreover, the socket 612 is held on a lower face of the connector 710 to be coupled to the connector 710. In another embodiment, the socket 612 may be coupled to the connector 710 via a printed board.

The connector 710 is an example of a socket-side connector provided in the socket 612, including a plurality of signal terminals 728. Alternatively, the connector 710 may adopt the configuration of including one signal terminal 728. Each of the signal terminals 728 is electrically coupled to the terminal 752 of the device under test 750 via a wiring provided in the socket 612. The connector 710 may be provided in the socket 612 via a printed board coupling the connector 710 to the socket 612.

The test head 504 includes an enclosure 602 (see FIG. 2), a test module 604, and a connector 702. The connector 702 is an example of a board-side connector provided on an end section of the test module 604, including a plurality of signal terminals 722. Alternatively, the connector 702 may adopt the configuration of including one signal terminal 722. The signal terminal 722 is electrically coupled to a driver or a comparator provided in the test module 604.

The common motherboard 506 includes a holding base 606, a connector holding unit 608, a connector 614, a connector 704, and cables 706. The holding base 606 holds the connector 704 on a lower face thereof. Moreover, the connector 614, the connector 704, and the plurality of cables 706 compose a cable unit 708. Alternatively, the cable unit 708 may adopt the configuration of including the connector 614, the connector 704, and one cable 706.

The connector 614 is an example of a socket fitting connector, fitted with the connector 710, when the common motherboard 506 and the product type corresponding unit 508 are coupled to each other. Accordingly, the product type corresponding unit 508 becomes mechanically attached or detached to or from the common motherboard 506 depending upon whether the connectors 710 and 614 are fitted with each other or not. Therefore, according to this embodiment, the product type corresponding unit 508 can be replaced depending upon the change of the product type of the device under test 750, thereby it is possible to test various types of devices under test 750 with the minimum required replacement.

The connector 704 is an example of a board fitting connector, fitted with the connector 702, when the common motherboard 506 and the test head 504 are coupled to each other. Accordingly, the common motherboard 506 becomes mechanically attached or detached to or from the test head 504 depending upon whether the connectors 702 and 704 are fitted with each other or not.

Moreover, each of the plurality of cables 706 is an example of a transmission cable, coupling the connectors 704 and 614 and transmitting a transmission signal to be transmitted between the connectors 704 and 614. The transmission signal is at least either the test signal or the output signal of the device under test 750.

Accordingly, the cable unit 708 transmits the transmission signal between the socket 612 and the test module 604. Therefore, according to this embodiment, it is possible to properly transmit the transmission signal between the test module 604 and the device under test 750.

Here, if the product type corresponding unit 508 and the common motherboard 506 are electrically coupled by soldering, it is difficult to replace the product type corresponding unit 508 in response to the product type of the device under test 750. However, according to this embodiment, since the product type corresponding unit 508 and the common motherboard 506 are coupled via the connectors 710 and 614, it is possible to properly attach the product type corresponding unit 508 to be replaceable. Moreover, the connector 710 is fitted with the connector 614 at a predetermined position where the connector 614 is provided. In this case, it is possible to use the common motherboard 506 in common even though the product types of the devices under test 750 are different. Therefore, the test apparatus 500 (see FIG. 1) can properly test a plurality of types of devices under test 750.

Moreover, if one end or the other end of the cable 706 is coupled to the product type corresponding unit 508 or the common motherboard 506 by soldering, impedance mismatch occurs at the place of soldering, so the signal might not be properly transmitted. According to this embodiment, however, the cables 706 are coupled to the product type corresponding unit 508 and the test head 504 via the connectors 614 and 704. Therefore, according to this embodiment, the impedance with regard to the connectors 614 and 704 is matched, so the transmission signal can be properly transmitted. Further, by using the connectors 614 and 704, it is possible to wire the plurality of cables 706 with high density.

In addition, the test head 504 may include a plurality of connectors 702 corresponding to a plurality of test modules 604. Moreover, the common motherboard 506 may include a plurality of cable units 708 corresponding to a plurality of connectors 702. The product type corresponding unit 508 may include a plurality of connectors 710 corresponding to a plurality of cable units 708.

Moreover, the connectors 710, 614, 704 and 702 may have their impedance of about 50 Ω. It is preferable that the reflection ratio of each of the connectors 710, 614, 704 and 702 is less than 3% to the signal of which period is about 100 ps. It is preferable that the connectors 710 and 614 should have their detachable durability more than 5,000 times. It is preferable that the connectors 704 and 602 should have their detachable durability more than 25,000 times.

The signal terminals 728, 726, 724 and 722 may be provided with the signal density more than 0.45 mm². It is preferable that the coupling resistance of the signal terminals 728 and 726 and the coupling resistance of the signal terminals 724 and 722 should be 85 mΩ or less. It is preferable that the cable 706 should have its impedance of about 49 to 51 Ω and its attenuation characteristic of −2 dB/m or less to the signal of about 3 GHz.

In this case, it is possible to properly transmit the high speed signal of 2.133 Gbps or more. Moreover, it is possible to wire the cable 706 with the high density 1.5 or more times the density in case of soldering. According to this embodiment, it is possible to properly test the device under test 750.

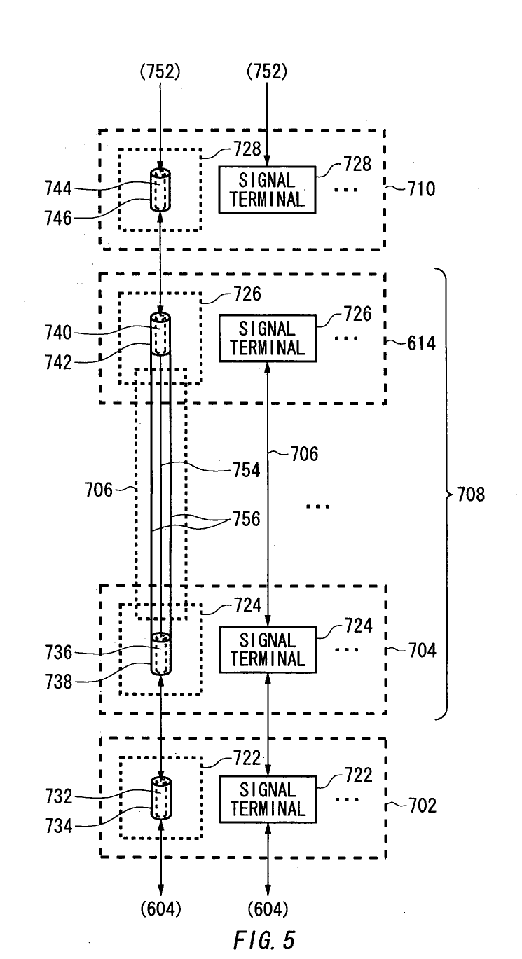

FIG. 5 shows an example of the detailed configuration of the connector 710, the connector 702, and the cable unit 708. Further, except the matters described below, the components in FIG. 5 bearing the same reference numerals as those in FIG. 4 have the same functions as those in FIG. 4. Therefore, the explanation about these components will be omitted.

In this embodiment, the connector 710 includes a plurality of signal terminals 728. Each of the signal terminals 728 is a coaxial cable, including a core wire 744 and a shield 746. The core wire 744 is an example of a socket-side core wire, electrically coupled to a terminal 752 of the device under test 750 (see FIG. 4) held by the socket 612 (see FIG. 4). Accordingly, the core wire 744 sends or receives the transmission signal to or from the device under test 750 via the socket 612. The shield 746 is a socket-side shield, surrounding the core wire 744. In this case, a plurality of shields 746 corresponding to a plurality of signal terminals 728 are electrically independent from one another in the connector 710 and respectively surround the core wires 744 corresponding to the same signal terminals 728.

The connector 702 includes a plurality of signal terminals 722. Each of signal terminals 722 is a coaxial terminal, including a core wire 732 and a shield 734. The core wire 732 is a board-side core wire, electrically coupled to the test module 604. Accordingly, the core wire 732 sends or receives the transmission signal to or from the test module 604. The shield 734 is a board-side shield, surrounding the core wire 732. In this case, a plurality of shields 734 corresponding to a plurality of signal terminals 722 are electrically independent from one another in the connector 702 and respectively surround the core wires 732 corresponding to the same signal terminals 722. The shield 734 is coupled to the test module 604 and grounded inside the test module 604.

The cable unit 708 includes a plurality of connectors 614 and 704 and a plurality of cables 706. The connector 614 includes a plurality of signal terminals 726. Each of the signal terminals 726 is a coaxial terminal, including a core wire 740 and a shield 742. The core wire 740 is an example of a transmission core wire, coupled to the core wire 744 and sending or receiving the transmission signal to or from the core wire 744 when the connectors 710 and 614 are fitted with each other. The shield 742 is an example of a transmission shield, surrounding the core wire 740. In this case, a plurality of shields 742 corresponding to a plurality of signal terminals 726 are electrically independent from one another in the connector 614 and respectively surround the core wire 740 corresponding to the same signal terminal 726. The shield 742 is coupled to the shield 746 when the connectors 710 and 614 are fitted with each other.

The connector 704 includes a plurality of signal terminals 724. Each of the signal terminals 724 is a coaxial terminal, including a core wire 736 and a shield 738. The core wire 736 is an example of the transmission core wire, coupled to the core wire 732 and sending or receiving the transmission signal to or from the core wire 732, when the connectors 704 and 702 are fitted with each other. The shield 738 is an example of the transmission shield, surrounding the core wire 736. In this case, a plurality of shields 738 corresponding to a plurality of signal terminals 724 are electrically independent from one another inside the connector 704 and respectively surround the core wire 736 corresponding to the same signal terminal 724. The shield 738 is coupled to the shield 734, when the connectors 704 and 702 are fitted with each other.

The plurality of cables 706 couple the plurality of signal terminals 726 and the plurality of signal terminals 724. Moreover, each of the cables 706 includes a transmission line 754 and a shield 756.

One end or the other end of the transmission line 754 is coupled to the core wires 740 and 736. Accordingly, when each of the connectors 614 and 704 is fitted with each of the connectors 710 and 702, the transmission line 754 couples the core wires 744 and 732. Accordingly, the transmission line 754 sends or receives the transmission signal between the core wires 744 and 732.

The shield 756 is an example of a cable shield. The shields 756 of a plurality of cables 706 are electrically independent from one another between the connectors 614 and 704 and respectively surround the corresponding transmission lines 754 of the same cables 706. Moreover, one end or the other end of the shield 756 is coupled to the shields 742 and 738. Accordingly, when each of the connectors 614 and 704 are fitted with each of the connectors 710 and 702, the shield 756 is electrically coupled to the shields 746 and 734.

As described above, the core wire 740 of each of the signal terminals 726 in the cable unit 708 is coupled to the transmission line 754 of each of the plurality of cables 706. Moreover, the core wire 736 of each of the signal terminals 724 is coupled to the transmission line 754 in each of the plurality of cables 706.

Moreover, the shield 742 of each of the signal terminals 726 couples the shield 756 of each of the plurality of cables 706 and each of the plurality of shields 746. The shield 738 of each of the signal terminals 724 couples each of the plurality of shields 756 and each of the plurality of shields 734.

Accordingly, the test apparatus 500 (see FIG. 1) of this embodiment transmits the transmission signal between the test module 604 and the terminal 752, holding the coaxial structure. Therefore, according to this embodiment, it is possible to transmit the signal between the test module 604 and the device under test 750 with high precision. Moreover, it is possible to perform the test of the device under test 750 with high precision.

Further in this embodiment, one of the signal terminals 728 and 726 is a male terminal, and the other one of the signal terminals 728 and 726 is a female terminal. Moreover, one of the signal terminals 724 and 722 is a male terminal, and the other one of the signal terminals 724 and 722 is a female terminal. According to this embodiment, it is possible to properly couple the test module 604 and the device under test 750.

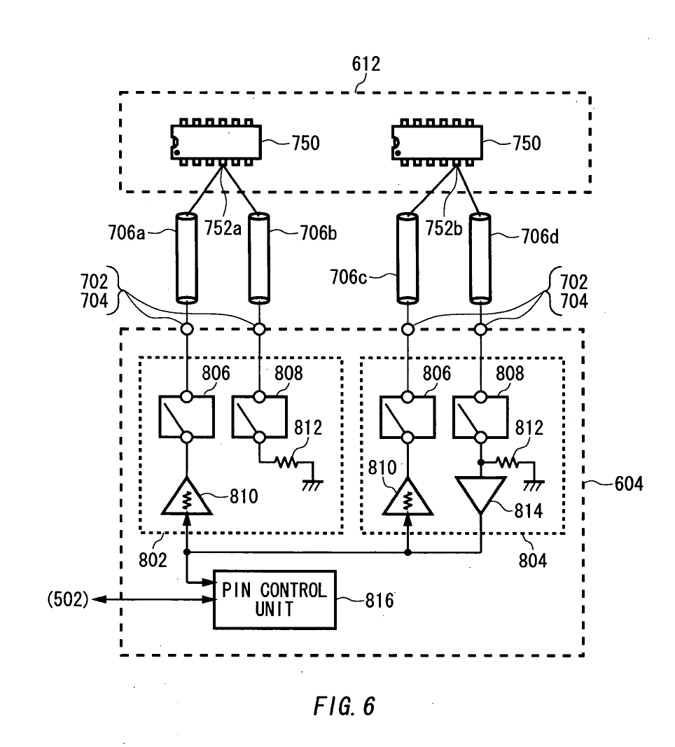

FIG. 6 shows an example of the configuration of the test module 604 as well as the cable 706 and the socket 612. Further, except the matters described below, the components in FIG. 6 bearing the same reference numerals as those in FIG. 4 or 5 have the same functions as those in FIG. 4 or 5. Therefore, the explanation about these components will be omitted. In this embodiment, the test module 604 includes a driver pin 802, an I/O pin 804, and a pin control unit 816. The test module 604 may include a plurality of driver pins 802 and/or a plurality of I/O pins 804.

The driver pin 802 includes a driver 810, a resistor 812, and a plurality of switches 806 and 808. The driver 810 outputs the test signal in response to the instruction of the pin control unit 816. In this embodiment, the driver 810 provides the test signal to a terminal 752a of the device under test 750 via the switch 806 and a cable 706a. The terminal 752a may be an input terminal of the device under test 750.

The switch 806 is provided between the output port of the driver 810 and the connector 702, switching to determine whether to output the output of the driver 810 to the cable 706a. The switch 806 determines the timing at which the test signal is provided to the device under test 750 by switching on or off in response to the instruction of the pin control unit 816. Accordingly, the driver pin 802 supplies the device under test 750 with the test pattern corresponding to the test signal.

The switch 808 is coupled to the terminal 752a via the cable 706b. Accordingly, the switch 808 receives the test signal outputted by the driver 810 via a plurality of cables 706a and 706b. Moreover, the switch 808 provides the test signal received to one end of the resistor 812 of which other end is grounded. Accordingly, the driver pin 802 is coupled to the terminal 752a by a DTL (Dual Transmission Line). In this case, by reducing the test signal from reflecting in the terminal 752a, it is possible to transmit the test signal with high precision. Moreover, it is possible to control the timing of the transmission of the test signal with high precision. Further, the switch 808 switches on or off in response to the instruction of the pin control unit 816, synchronized with the switch 806.

The I/O pin 804 includes a driver 810, a resistor 812, a plurality of switches 806 and 808, and a comparator 814. Each of the switches 806 and 808 in the I/O pin 804 is coupled to a terminal 752b of the device under test 750 via each of a plurality of cables 706c and 706d. The terminal 752b may be an input/output terminal of the device under test 750. The driver 810 provides the test signal to the terminal 752b via the switch 806 and the cable 706c.

Moreover, the comparator 814 receives and samples the output signal outputted to the terminal 752b via the cable 706d and the switch 808 by the device under test 750. Moreover, the comparator 814 provides the value sampled to the pin control unit 816. Accordingly, the I/O pin 804 detects the value of the output signal of the device under test 750.

Further, the switch 808 becomes the on state both when the driver 810 outputs the test signal and when the comparator 814 samples the output signal of the device under test 750. Except the above matters, the driver 810, the resistor 812, and the plurality of switches 806 and 808 in the I/O pin 804 may have the same function as those of the driver 810, the resistor 812, and the plurality of switches 806 and 808 in the driver pin 802.

The pin control unit 816 controls the driver 810 to output the test signal in response to the instruction of the main frame 502. Moreover, the pin control unit 816 receives the value sampled by the comparator 814 supplies it to the main frame 502. According to this embodiment, it is possible to properly input or output the signal from or to the device under test 750.

Further, since the operation speed of the electronic device recently becomes high, the high performance transmission line is required. In this embodiment, by using the plurality of connectors 702, 704, 614 and 710 (see FIG. 5), there is a margin for the number of wirings because the cables 706 can be mounted with high density. Therefore, it is possible to couple the driver pin 802 and/or the I/O pin 804 and the device under test 750 by the DTL wiring. In this case, it is possible to reduce the reflection in the terminal 752 and properly supply the test signal. Therefore, according to this embodiment, it is possible to test the device under test 750 with high precision.

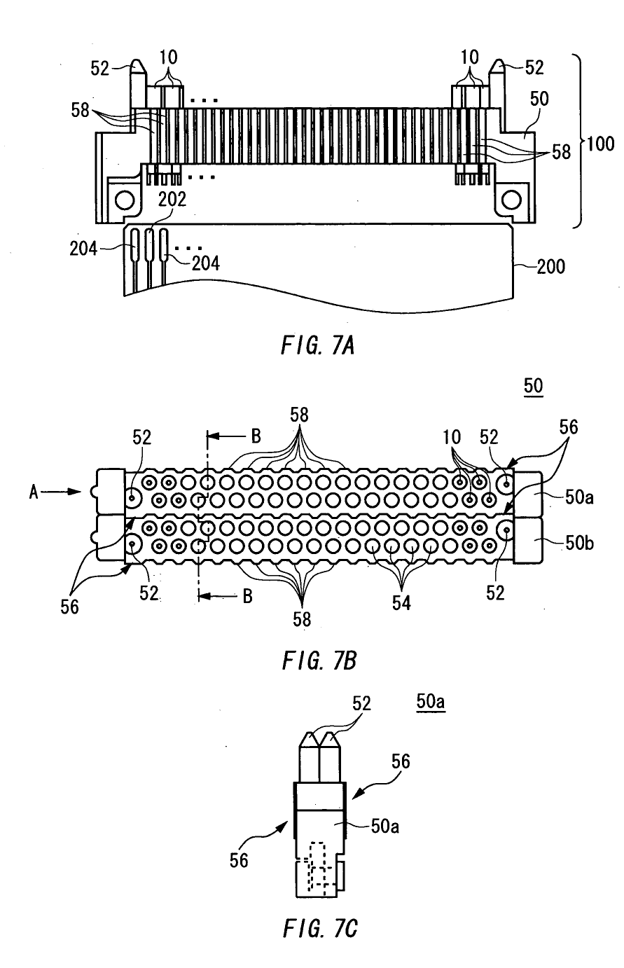

FIG. 7 shows the configuration of a plug connector 100 which is an example of the connector 702 (see FIG. 5). One end of the plug connector 100 is coupled to a receptacle-side connector and the other end thereof is mounted on one side of the plug-side board 200, so that it can relay the electrical signal between the receptacle-side connector and the plug-side board 200. Further, in this embodiment, the receptacle-side connector is the connector 704 (see FIG. 5). Moreover, the plug-side board 200 is the test module 604 (see FIG. 5).

The plug-side board 200 includes a plurality of board signal wires 202 for transmitting signals and board ground wires 204 grounded. The board signal wires 202 are an example of signal wires for transmitting the transmission signal, and the board ground wires 204 are an example of ground wires. Moreover, the plug connector 100 includes a plug-side housing 50 and a plurality of plug signal terminals 10. In this embodiment, the plug signal terminals 10 are used as the signal terminals 722 (see FIG. 5).

FIG. 7A shows the plug connector 100 viewed perpendicularly to the surface of the plug-side board 200. FIG. 7B shows the plug connector 100 viewed perpendicularly to a connector coupling face on which the plug connector 100 is coupled to the receptacle-side connector. In this embodiment, two plug-side housings 50a and 50b are overlapping each other. FIG. 7C shows the plug-side housing 50a viewed from A shown in FIG. 7B.

The plug-side housing 50 extends shorter than the length of each of the plug signal terminals 10, perpendicular to an approximately rectangular-shaped upper face approximately parallel to the connector coupling face. The plug-side housing 50 includes a plurality of through holes 54, two positioning members 52, two lateral faces 56, and a plurality of convex sections 58.

The plurality of through holes 54 penetrates the plug-side housing 50 in the shape of an approximate cylinder, approximately perpendicular to the upper face of the plug-side housing 50 towards a rear face opposite the upper face. Each of the plurality of plug signal terminals 10 is inserted respectively into the through holes 54. Accordingly, the plug-side housing 50 holds the plurality of signal terminals.

Moreover, the plurality of through holes 54 are arranged in rows at approximately regular intervals in a predetermined arrangement direction with regard to the upper face of the plug-side housing 50. The plurality of through holes 54 form first and second rows parallel to each other. Accordingly, the plug-side housing 50 holds at least a part of each of the plurality of signal terminals 10, arranging it with the mutually parallel first and second rows.

In addition, the plurality of through holes 54 form a zigzag pattern, so that the approximate center of one of the through holes 54 in the second row can be disposed on the approximately perpendicular bisector of a line that links both the approximate centers of two adjacent through holes 54 in the first row. Accordingly, the plug-side housing 50 holds the plurality of signal terminals 10, arranging them in two rows by the zigzag pattern in which the mutually parallel first and second rows are arranged. Further, the plug-side housing 50 in this embodiment holds a few plug signal terminals 10 at both ends of each of the first and second rows.

The two lateral faces 56 are parallel to each other in the axis direction and the arrangement direction of the plug signal terminals 10 in the plug-side housing 50. The lateral faces 56 include a plurality of convex sections 58. The plurality of convex sections 58 respectively curve outwards at each of the positions, where the plurality of plug signal terminals 10 are held, in the direction perpendicular to the lateral faces 56, extending in the axis direction of the plug signal terminals 10 and surrounding the plug signal terminals 10. Accordingly, the lateral faces 56 are shaped as waves with crests and troughs. The concave section between the adjacent convex sections 58 receives the protrusion of the convex section 58 formed on another plug-side housing 50. Further, the shape of the convex sections 58 and the concave sections may be replaced by a trapezoid, a rectangle, a curved face, etc.

Further, in this embodiment, the plug-side housing 50 holds the same number of signal terminals 10 for each of the first and second rows. Accordingly, the two plug-side housing 50 can be properly overlapped by fitting the respective convex and concave sections on each of the lateral faces 56 in the wavy form.

The two positioning members 52 protrudes from the surface of the plug-side housing 50 in the axis direction of the plug signal terminals 10 at the positions, where they form the zigzag pattern together with the plurality of plug signal terminals 10, so that they are adjacent respectively to the plug signal terminals 10 disposed at one end of each of the first and second rows, facing each other with the plurality of plug signal terminals 10 being interposed. Accordingly, they determine the position of the receptacle-side connector coupled to the plug connector 100.

Moreover, since the two positioning members 52 are disposed to face each other at both the ends of each of the two rows, the same number, arranged in the zigzag pattern, each of the positioning members 52 is symmetrical to the approximate center of the upper face. Accordingly, the two positioning members 52 can stably couple the plug connector 100 and the receptacle-side connector. Further, the plug-side housing 50 may include two or more positioning members.

Further, the plug connector 100 may be used as the connector 710 (see FIG. 5). In this case, the plug connector 100 is coupled to the connector 614 (see FIG. 5). Moreover, the plug signal terminals 10 are used as the signal terminals 728 (see FIG. 5). The socket 612 (see FIG. 4) may include signal wires and ground wires in the same shape as the board signal wires 202 and the board ground wires 204.

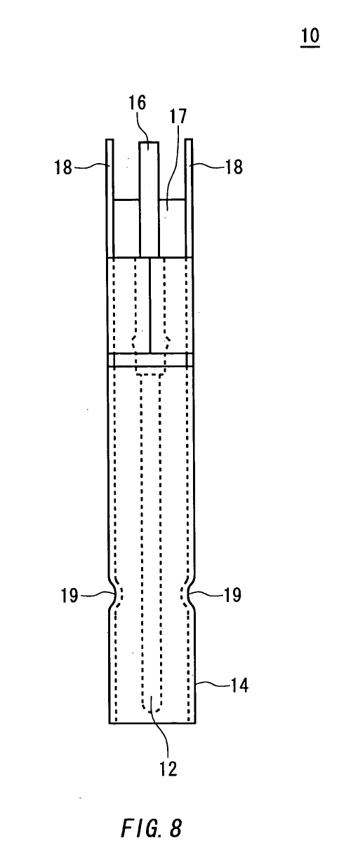

FIG. 8 shows an example of the detailed configuration of the plug signal terminal 10. The plug signal terminal 10 includes a plug signal core wire 12, a plug core wire shield 14, an insulating member 17, a plug signal electrode 16, two plug ground electrodes 18, and a circularly extending section 19. In this embodiment, the plug signal core wire 12 and the plug core wire shield 14 are used as the core wire 732 and the shield 734 (see FIG. 5). The plug signal core wire 12 and the plug core wire shield 14 may be used as the core wire 744 and the shield 746 (see FIG. 5).

The plug signal core wire 12 is a conductor made of metal, extending linearly. The plug core wire shield 14 is shaped like a cylinder of which diameter is approximately the same as the inner diameter of the through hole 54 (see FIG. 7). The plug core wire shield 14 is a conductor insulated from the plug signal core wire 12, extending in the axis direction of the plug signal core wire 12 and surrounding the plug signal core wire 12 to be longer than the plug signal core wire 12.

The insulating member 17 is an insulator such as resin, filled between the plug core wire shield 14 and the plug signal core wire 12. Accordingly, the plug core wire shield 14 and the plug signal core wire 12 are electrically insulated.

The plug signal electrode 16 extends from the plug signal core wire 12, approximately parallel to the axis direction of the plug signal core wire 12. Moreover, the two plug ground electrodes 18 extend in the axis direction of the plug core wire shield 14, facing each other with the plug signal electrode 16 being interposed.

The circularly extending section 19 circularly extends around the plug signal core wire 12 near one end of the plug signal core wire 12 with regard to a part of the surface of the plug core wire shield 14, protruding from the inner surface of the plug core wire shield 14 surrounding the plug signal core wire 12 towards the plug signal core wire 12.

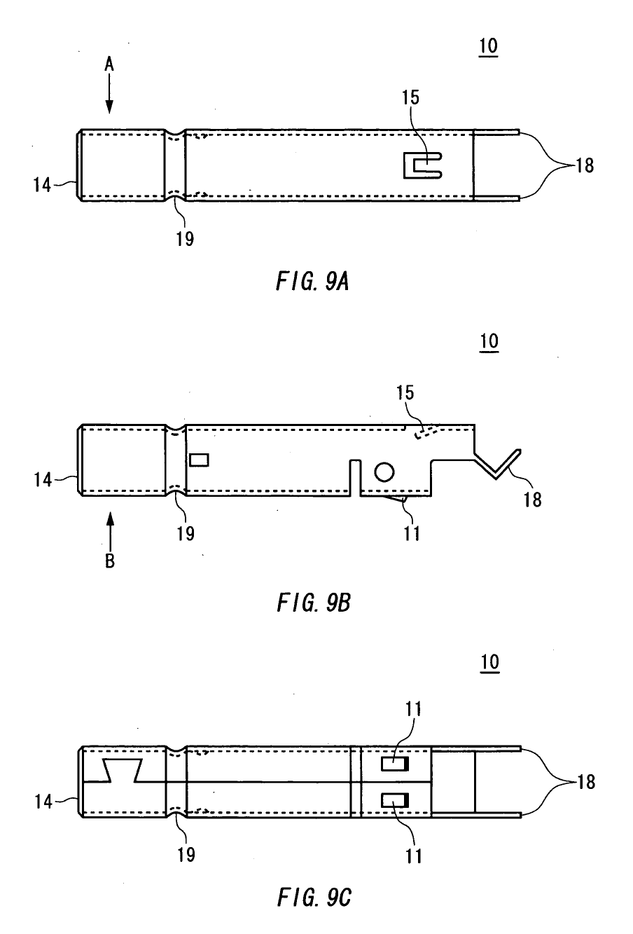

FIG. 9 shows an example of the detailed configuration of the plug core wire shield 14 and the plug ground electrodes 18. FIG. 9A shows the plug core wire shield 14 and the plug ground electrodes 18 viewed towards the surface of the plug-side board 200 (see FIG. 7). FIG. 9B shows the plug core wire shield 14 and the plug ground electrodes 18 viewed from A. FIG. 9C shows the plug core wire shield 14 and the plug ground electrodes 18 viewed from B. The plug core wire shield 14 includes a protrusion 11 and a stopper 15.

The protrusion 11 protrudes outwards from the surface of the plug core wire shield 14. The protrusion 11 locks the plug signal terminal 10 (see FIG. 8) on the inner surface of the through hole 54 (see FIG. 7), into which the plug signal terminal 10 is inserted, of the plug-side housing 50.

The stopper 15 extends inwards from the surface of the plug core wire shield 14, holding the insulating member 17 (see FIG. 8). Accordingly, the insulating member 17 fixes the plug signal core wire 12 (see FIG. 8). As above, in this embodiment, it is possible to firmly fix the plurality of plug signal terminals 10 to the plug-side housing 50 while it is insulated from the plug core wire shield 14.

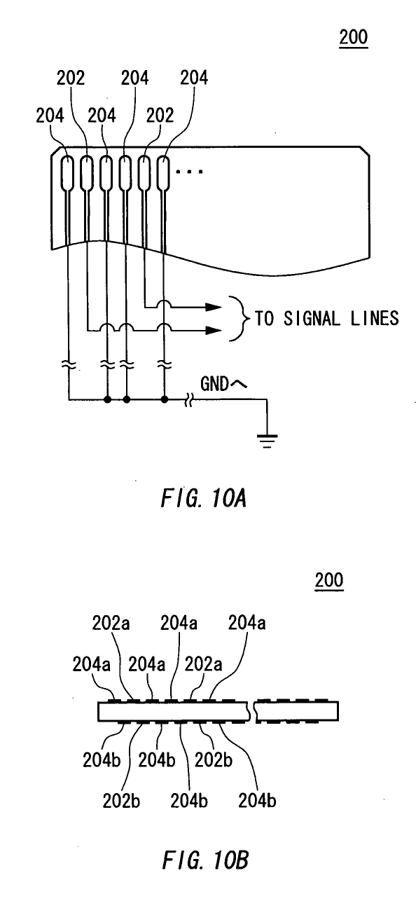

FIG. 10 shows an example of the detailed configuration of the plug-side board 200. FIG. 10A shows the surface of the plug-side board 200. FIG. 10B shows the plug-side board 200 viewed perpendicularly to the connector coupling face.

The plug-side board 200 is an approximately rectangular board, approximately parallel to the axis direction of the plug signal terminals 10. The plug-side board 200 includes the plurality of board signal wires 202a and the plurality of board ground wires 204a on its front face thereof and the plurality of board signal wires 202b and the plurality of the board ground wires 204b on its rear face. The board signal wires 202 are electrically independent from one another, and each of the board ground wires 204 is grounded.

Each of the board signal wires 202a and the board signal wires 202b is arranged in the same zigzag pattern as the plurality of the plug signal terminals 10. Accordingly, the plug-side board 200 is properly coupled to the plurality of plug signal terminals 10.

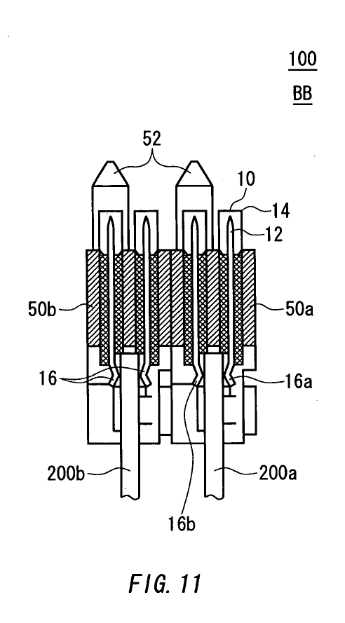

FIG. 11 shows the B-B sectional view of the plug connector 100 described in connection with FIG. 7B. The plug signal electrodes 16a and 16b of the plug signal terminals 10 in the first and second rows face each other with the plug-side board 200a being interposed. Accordingly, the plug signal electrode 16a of each of the plug signal terminals 10 in the first row contacts the corresponding board signal wire 202a (see FIG. 10B) of the front face of the plug-side board 200a, and the plug signal electrode 16b of each of the plug signal terminals 10 in the second row contacts the corresponding board signal wire 202b (see FIG. 10B) of the rear face of the plug-side board 200a. In this way, the plug ground electrodes 18 (see FIG. 8) in the first row contact the board ground wires 204a (see FIG. 10B) formed on the front face of the board, and the plug ground electrodes 18 (see FIG. 8) in the second row contact the board ground wires 204b (see FIG. 10B) formed on the front face of the board.

As above, the plurality of plug signal terminals 10 are provided in a corresponding manner respectively to the plurality of board signal wires 202. Moreover, the plug signal electrode 16 electrically couples the plug signal core wire 12 and the board signal wire 202 corresponding to the plug signal terminal 10, and the plug ground electrode 18 electrically couples the plug core wire shield 14 and the board ground wire 204. Accordingly, it is possible to transmit the signal received by the plug signal core wire 12 to the plug-side board 200.

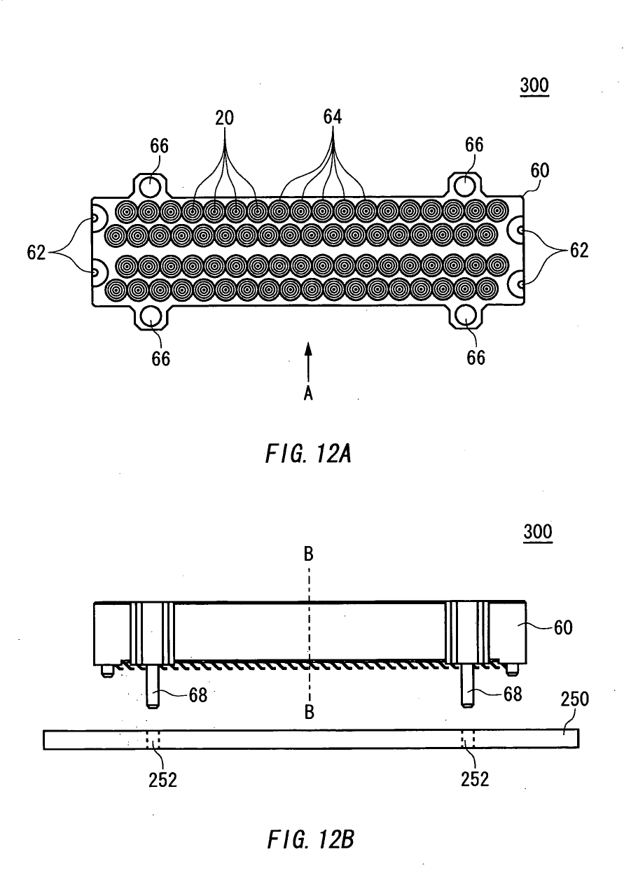

FIG. 12 shows the configuration of the receptacle connector 300 which is another example of the connector 702 (see FIG. 5). FIG. 12A shows the receptacle connector 300 viewed perpendicularly to the connector coupling face. FIG. 12B shows the receptacle connector 300 viewed from A.

The receptacle connector 300 is mounted on a receptacle-side board 250, coupled to the plug connector 100 (see FIG. 7) facing the receptacle-side board 250 with the receptacle connector 300 being interposed. The receptacle connector 300 includes a receptacle-side housing 60 and a plurality of receptacle signal terminals 20.

Further in this embodiment, the plug connector 100 is used as the connector 704 (see FIG. 5). In this case, the plug connector 100 is coupled to a plurality of cables 706 (see FIG. 5) in place of the plug-side board 200 (see FIG. 7). Moreover, the receptacle signal terminals 20 are used as the signal terminals 722. The receptacle-side board 250 may be the test module 604 (see FIG. 5). Except the matters described above, the plug connector 100 of this embodiment may have the same functions as the plug connector 100 described in connection with FIGS. 7 to 9. The plug signal core wire 12 and the plug core wire shield 14 (see FIG. 8) may be coupled to the transmission line 754 and the shield 756 in place of the plug-side board 200.

The receptacle-side housing 60 extends approximately as long as the receptacle signal terminal 20 approximately vertically from an upper face, which has approximately the same shape as the upper face of the two overlapping plug-side housings 50 (see FIG. 7). The receptacle-side housing 60 includes four positioning holes 62, a plurality of receiving sections 64, four housing through holes 66, and rivets 68.

The positioning holes 62 penetrate the receptacle-side housing 60 from the upper face of the receptacle-side housing 60 towards the rear face thereof, corresponding to the four positioning members 52 (see FIG. 7) provided in the plug connector 100. The four positioning holes 62 are respectively engaged with the four positioning members 52. Accordingly, the positioning members 52 and the positioning holes 62 can properly determine the position of the receptacle-side housing 60 to the plug-side housing 50.

The plurality of receiving sections 64 respectively receive the receptacle signal terminals 20. Further, each of the plurality of receiving sections 64 receives a part of each of the plug signal core wire 12 and the plug core wire shield 14. Accordingly, the receptacle-side housing 60 holds the plurality of receptacle signal terminals 20. In this embodiment, the plurality of receiving sections 64 respectively hold the plurality of receptacle signal terminals 20 at the positions corresponding to the plurality of plug signal terminals 10 (see FIG. 7) held by the plug-side housing 50 in four rows of the zigzag pattern.

The four housing through holes 66 penetrate from the upper face of the receptacle-side housing 60 towards the rear face thereof in the form of an approximate cylinder, facing each other every two holes in four rows of the zigzag pattern in the receptacle-side housing 60.

Each of the rivets 68 is formed of copper or aluminum in the shape of a cylinder of which diameter is the same as the inner diameter of the housing through holes 66. The rivets 68 are inserted into the housing through holes 66 and board through holes 252 formed in the receptacle-side board 250 in the direction from the receptacle-side housing 60 towards the receptacle-side board 250, so that one ends of the rivets 68 facing the plug connector 100 are received in the housing through holes 66, and the other ends protrude from the rear face of the receptacle-side board 250.

Here, the board through holes 252 penetrate from the front face of the receptacle-side board 250 facing the receptacle-side housing 60 towards the rear face thereof, corresponding to the housing through holes 66.

During the fastening operation with the rivets 68, one end of the rivets 68 facing the plug connector 100 are disposed not to protrude from the upper face of the receptacle-side housing 60, and the other ends of the rivets 68 protruding from the rear face of the receptacle-side board 250 are hammered flat. Accordingly, the rivets 68 fix the receptacle-side housing 60 to the receptacle-side board 250 without interference of the plug connector 100 and the one ends of the facing rivets 68.

Further, the receptacle connector 300 may be used as the connector 710 (see FIG. 5). In this case, the receptacle signal terminals 20 are used as the signal terminals 728 (see FIG. 5).

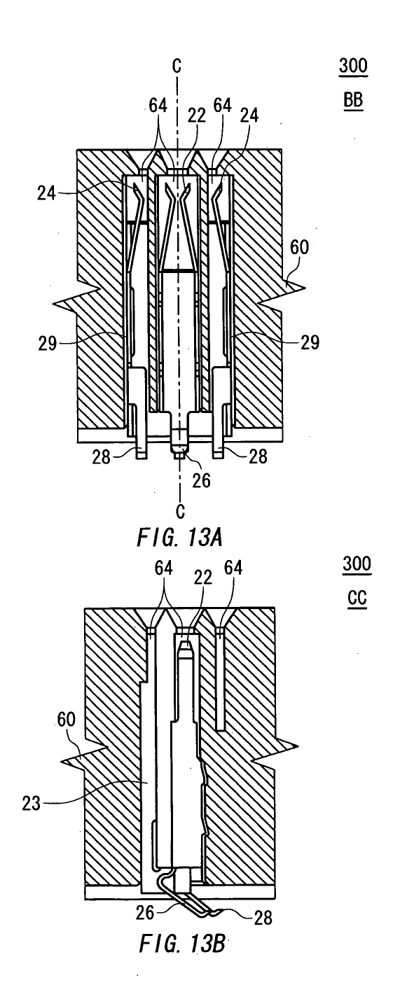

FIG. 13 shows an example of the detailed configuration of the receptacle connector 300. FIG. 13A shows the B-B sectional view of the receptacle signal terminal 20 in FIG. 12B. FIG. 13B shows the C-C sectional view of FIG. 13A. The receptacle signal terminal 20 includes a receptacle signal core wire 22, a receptacle core wire shield 24, a receptacle signal electrode 26, a semi-circular section 23, receptacle ground electrodes 28, and a semi-circularly extending section 29. The receptacle signal electrode 26 and the receptacle ground electrode 28 are coupled to the board signal wire and the board ground wire on the front face of the receptacle-side board 250 (see FIG. 12B).

Further, the receptacle signal core wire 22, the receptacle core wire shield 24 and the semi-circularly extending section 29 may have the same function as the plug signal core wire 12 and the plug core wire shield 14 of the plug signal terminals 10 described in connection with FIG. 8.

The semi-circular section 23 is a shield shaped like a semi-circle with regard to the receptacle core wire shield 24. Moreover, the semi-circularly extending section 29 has the same function as the circularly extending section 19, except that it is shaped like a semi-circle as compared with the circularly extending section 19 shaped like a circle.

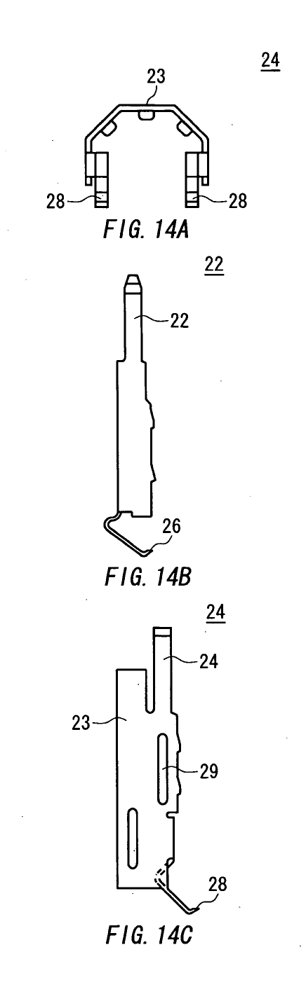

FIG. 14 shows an example of the detailed configuration of the receptacle signal core wire 22 and the receptacle core wire shield 24. FIG. 14A shows the receptacle core wire shield 24 viewed perpendicularly to the connector coupling face. FIG. 14B shows the receptacle signal core wire 22 viewed perpendicularly to the C-C sectional view in FIG. 13A. FIG. 14C shows the receptacle core wire shield 24 viewed in the same direction.

The semi-circular section 23 is formed near the end section close to the receptacle ground electrodes 28 with regard to the receptacle core wire shield 24, surrounding half the circumference of the receptacle signal core wire 22.

The receptacle signal electrode 26 extends from the receptacle signal core wire 22 in the direction away from the receptacle core wire shield 24, approximately perpendicular to the axis direction of the receptacle signal terminals 20 (see FIG. 12).

The two receptacle ground electrodes 28 extend from the receptacle core wire shield 24 in the direction from the arc of the semi-circular section 23 towards the chord thereof, facing each other with the receptacle signal electrode 26 being interposed and approximately parallel to the extending direction of the receptacle signal electrode 26.

Moreover, the receptacle signal core wire 22 is inserted into the inner side of the receptacle core wire shield 24 in the receiving section 64 (see FIG. 13). The receptacle signal core wire 22 and the receptacle core wire shield 24 are electrically insulated from each other by an insulator such as resin filled in the inner side of the receptacle core wire shield 24.

The receptacle-side housing 60 is formed of resin. Moreover, the receptacle core wire shield 24 is shaped like a semi-circle lacking a part. Accordingly, the insulator in the inner side of the receptacle core wire shield 24 and the resin of the receptacle-side housing 60 surrounding the outer side of the receptacle core wire shield 24 are connected in the lacking part so as to be integrally formed. Accordingly, it is possible to easily manufacture the receptacle-side housing 60 at a low cost.

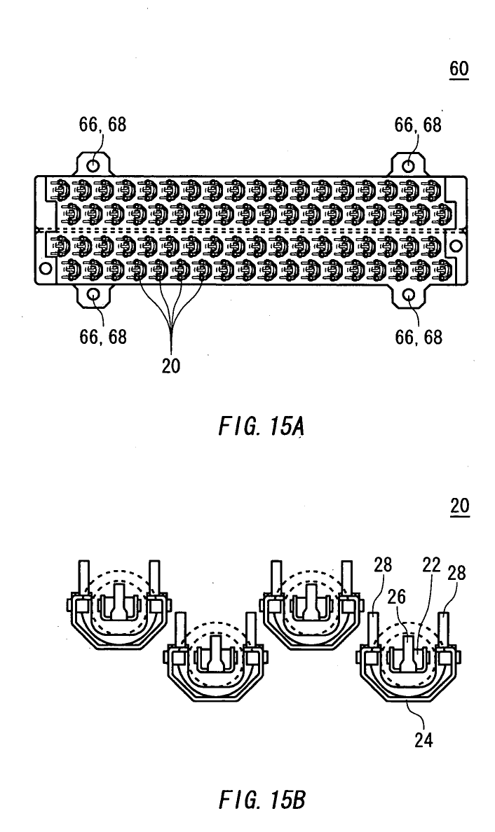

FIG. 15 shows an example of the detailed configuration of the receptacle-side housing 60. FIG. 15A shows the receptacle-side housing 60 viewed perpendicularly to the front face of the receptacle-side board 250 (see FIG. 12B). FIG. 15B shows the receptacle signal terminals 20 in further detail.

The plurality of receptacle signal terminals 20 are arranged in a predetermined arrangement direction in which each of the receptacle signal electrodes 26 extends. In this embodiment, each of the plurality of the receptacle signal terminals 20 is arranged in the half-moon direction as the arrangement direction.

In this case, the open space formed in the half-moon direction with regard to each of the receptacle signal terminals 20 is almost blocked by the other adjacent semi-circular section 23 in the half-moon direction. Accordingly, it is possible to reduce the effect of the noise such as the crosstalk from the close receptacle signal terminal 20 in the receptacle connector 300.

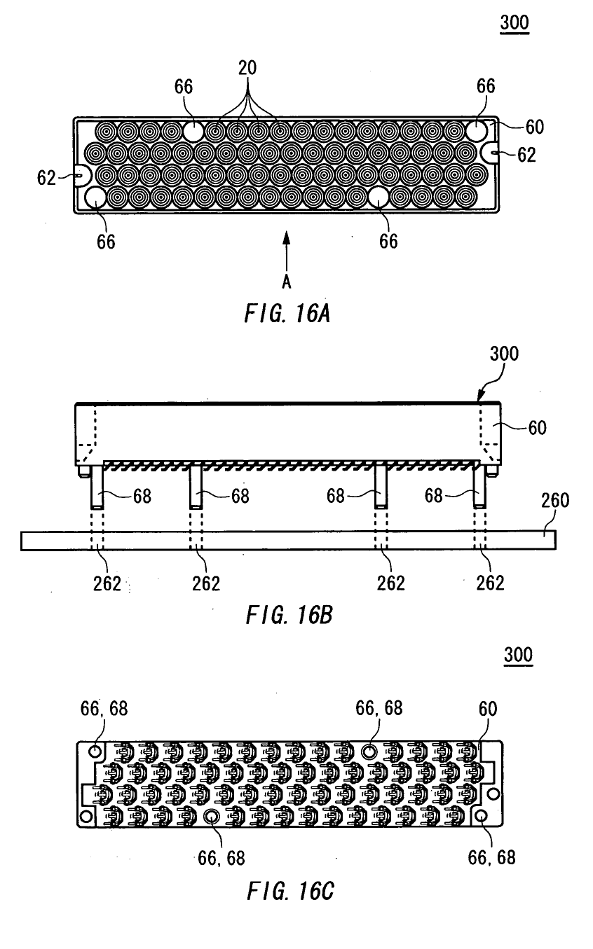

FIG. 16 shows another example of the configuration of the receptacle connector 300. FIG. 16A shows the receptacle connector 300 viewed perpendicularly to the connector coupling face. FIG. 16B shows the receptacle connector 300 viewed from A. FIG. 16C shows the receptacle-side housing 60 viewed perpendicularly to the front face of the receptacle-side board 260. Further, the configurations given the same symbols as those in FIG. 12 have the same functions as the configurations in FIG. 12, so they will not be described except the blow matters.

The four housing through holes 66 receiving the rivets 68 are arranged at the plurality of receiving sections 64 disposed in the zigzag pattern. The four housing through holes 66 of the embodiment are provided at the position where they can be fitted with the plug connector 100 inversed by 180 degrees in the direction facing the connector coupling face.

The receptacle-side board 260 has the board through holes 262 penetrating from the front face opposite the receptacle-side housing 60 towards the rear face at the corresponding place of the receptacle-side housing 60 to the housing through holes 66. In this embodiment, the receptacle-side housing 60 and the receptacle-side board 260 are firmly fixed by the rivets 68 inserted into the board through holes 262.

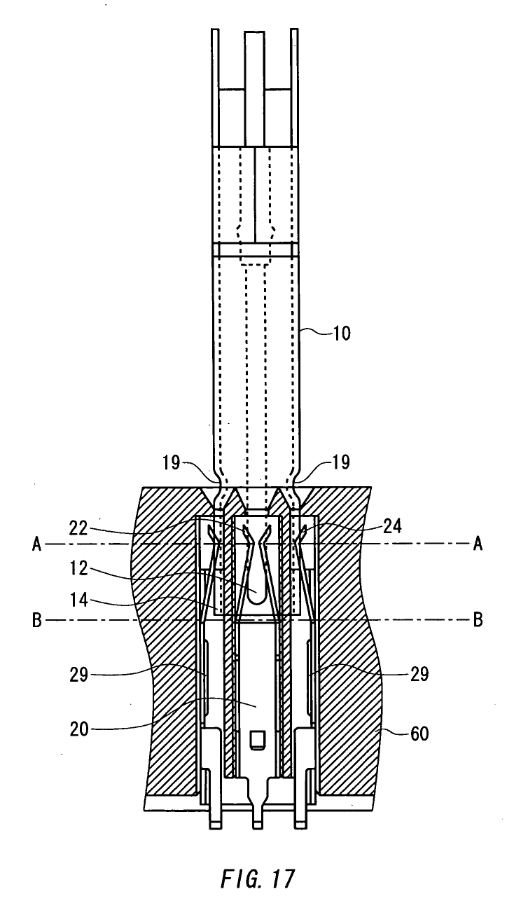

FIG. 17 shows the sectional view of the plug signal terminal 10 and the receptacle signal terminal 20 fitted with each other. Each of the plug signal terminal 10 and the receptacle signal terminal 20 may have the same function as either or both the signal terminals 722 or/and the signal terminals 724 (see FIG. 4). The plug signal terminal 10 and the receptacle signal terminal 20 may have the same function as either or both the signal terminals 728 or/and the signal terminals 726 (see FIG. 4).

In this embodiment, the plug signal terminal 10 is a male terminal, including the plug signal core wire 12 and the plug core wire shield 14. Moreover, the receptacle signal terminal 20 is a female terminal shaped for being fitted with the male terminal, including the receptacle signal core wire 22 and the receptacle core wire shield 24.

When the plug signal terminal 10 is inserted into the receptacle signal terminal 20, the receptacle signal core wire 22 presses the outer face of the plug signal core wire 12 contacting the inner face of the receptacle signal core wire 22 by its elastic force. The receptacle core wire shield 24 presses the outer face of the plug core wire shield 14 contacting the inner face of the receptacle core wire shield 24 by its elastic force. Accordingly, the receptacle signal core wire 22 and the receptacle core wire shield 24 are firmly fitted with the plug signal core wire 12 and the plug core wire shield 14.

Further in this embodiment, when the plug connector 100 and the receptacle connector 300 are coupled so that the plug signal terminal 10 and the receptacle signal terminal 20 are coupled, the plug core wire shield 14 contacts the receptacle core wire shield 24 before the plug signal core wire 12 is coupled to the receptacle signal core wire 22.

Moreover, until the end of the plug core wire shield 14 is inserted up to a predetermined position inside the receptacle core wire shield 24, the receptacle core wire shield 24 presses the outer face of the plug core wire shield 14 by the elastic force gradually increasing as the end progresses into the receptacle core wire shield 24. When the end of the plug core wire shield 14 is inserted at the predetermined position, the elastic force by which the receptacle core wire shield 24 presses the outer face of the plug core wire shield 14 is approximately constant. After the end of the plug core wire shield 14 is inserted into the predetermined position, the plug signal core wire 12 is coupled to the receptacle signal core wire 22.

Accordingly, the plug signal core wire 12 is inserted into the receptacle signal core wire 22 after the receptacle core wire shield 24 is broadened, so it is possible to reduce the force required to insert the plug signal terminal 10 into the receptacle signal terminal 20. Moreover, it is possible to prevent the plug signal core wire 12 from breakage.

Moreover, in this embodiment, as the shield the terminal comes into the contact state earlier than the signal terminal, the electronic circuit is protected because the static electricity charged in the plug signal terminal 10 is set free to the ground terminal, or the DUT is protected because the power supply sequence is predetermined.

As above, each of the receptacle signal core wire 22 and the receptacle core wire shield 24 is fitted with each of the plug signal core wire 12 and the plug core wire shield 14. Moreover, the plug signal terminals 10 are electrically and mechanically coupled to the receptacle signal terminals 20 securely.

Further in this embodiment, the receptacle core wire shield 24 is formed in order that the distance between it and the plug core wire shield 14 becomes gradually broad from the AA section to the BB section. Accordingly, the receptacle core wire shield 24 operates with an elastic force. With regard to the space for the operation, there a gap, where the insulator of the receptacle-side housing 60 such as resin is not filled, between the plug core wire shield 14 and the receptacle core wire shield 24. In the same way, there is also a gap, where the insulator such as resin is not filled, between the plug signal core wire 12 and the receptacle signal core wire 22. For that reason, the impedance value at the fitting face of the plug signal terminal 10 and the receptacle signal terminal 20 with regard to the range of the AA section to the BB section is larger than the impedance at the fitting face of other places filled with resin.

In this embodiment, however, since the groove of the circularly extending section 19 described in connection with FIG. 8 lessens the distance between the plug signal core wire 12 and the plug core wire shield 14, the impedance with regard to the plug signal terminal 10 is corrected down. In the same way, since the groove of the semi-circularly extending section 29 described in connection with FIG. 13 lessens the distance between the receptacle signal core wire 22 and the receptacle core wire shield 24, the impedance with regard to the receptacle signal terminal 20 is corrected down. Accordingly, in this embodiment, it is possible to reduce the deterioration of the signal caused by impedance mismatch.

Moreover, although the plug signal terminal 10 is a male terminal and the receptacle signal terminal 20 is a female terminal in this embodiment, alternatively, one side of the plug signal core wire 12 and the plug core wire shield 14 and the receptacle signal core wire 22 and the receptacle core wire shield 24 may be a male terminal whereas the other side thereof may be a female terminal.

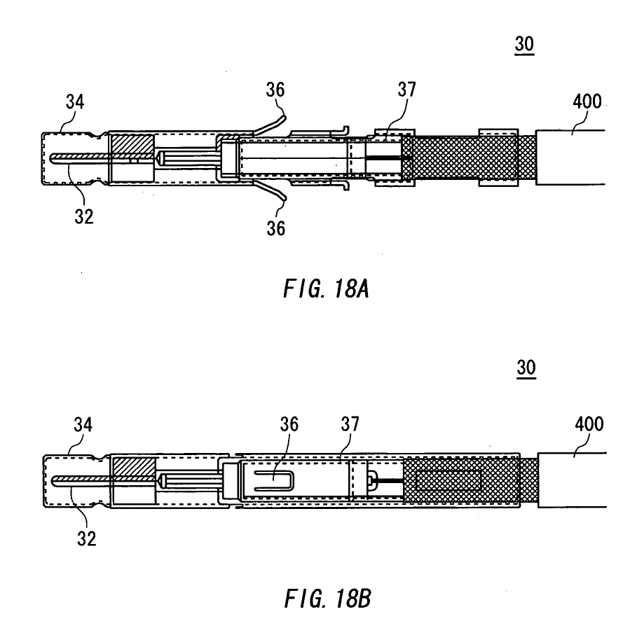

FIG. 18 shows another example of the configuration of the plug signal terminal 30. FIG. 18A shows an example of the configuration of the plug signal terminal 30. FIG. 18B shows an example of the configuration of the plug signal terminal 30 rotated by 90 degrees around the axis direction. In this embodiment, the plug signal terminal 30 is a plug-side connector, holding the plug-side housing. The plug signal terminal 30 includes a plug signal core wire 32, a first shield 34, a protruding section 36, and a second shield 37.

Moreover, in this embodiment, the plug signal terminal 30 is used as the signal terminal 724 or the signal terminal 726 (see FIG. 4). In this case, the receptacle connector 300 is used as the connector 702 or the connector 710 (see FIG. 4).

The plug signal core wire 32 extends linearly, made of a conductor such as metal. One end of the plug signal core wire 32 facing a coaxial cable 400 is electrically coupled to the center conductor of the coaxial cable 400. Further in this embodiment, the coaxial cable 400 is used as the cable 706 (see FIG. 5). The center conductor of the coaxial cable 400 may be the transmission line 754 (see FIG. 5).

The first shield 34 extends from the vicinity of the end of the plug signal core wire 32 in the axis direction of the plug signal core wire 12, formed of a conductor electrically insulated from the plug signal core wire 32 and surrounding the plug signal core wire 32. The first shield 34 is received into a through hole, of which diameter is approximately the same as the first shield 34, formed in the plug-side housing.

The protruding section 36 protrudes in the direction away from the plug signal core wire 32, extending from the end of the first shield 34. Accordingly, the plug signal terminal 30 is locked on the surface of the plug-side housing. In this embodiment, the plug-side housing holds a plurality of plug signal terminals 30 at the positions corresponding to the plurality of receptacle signal terminals 20 described in connection with FIG. 12 or 15.

The second shield 37 is formed of a conductor electrically insulated from the plug signal core wire 32, extending from its end in the axis direction and surrounding the plug signal core wire 32. The end of the second shield 37 is disposed to face the first shield 34, inserted between the plug signal core wire 32 and the first shield 34 near the protruding section 36. The other end of the second shield 37 is disposed to face the coaxial cable 400, electrically coupled to the outer conductor of the coaxial cable 400 and the second shield 37 by soldering.

The plug-side connector configured as above can properly hold the plurality of plug signal terminals 30 by the plug-side housing. Moreover, the plug-side connector can properly relay the electrical signal between the receptacle-side connector and the coaxial cable 400 to be fitted with each other.

As obvious from the description above, according to the present invention, it is possible to properly perform the test of the device under test.

Although the present invention has been described by way of exemplary embodiments, it should be understood that those skilled in the art might make many changes and substitutions without departing from the spirit and the scope of the present invention, which is defined only by the appended claims.

1. A device interface apparatus for providing a device under test with a test signal to test said device under test and receiving an output signal outputted from said device under test, comprising:
a pin electronics board comprising:
a driver for outputting said test signal; and
a comparator for sampling said output signal;
a board-side connector provided on an end section of said pin electronics board, wherein said board-side connector comprises:
a board-side core wire for transmitting a transmission signal, which is at least either said test signal or said output signal; and
a board-side shield surrounding said board-side core wire;
a socket contacting a terminal of said device under test for holding said device under test;
a socket-side connector provided on said socket, wherein said socket-side connector comprises:
a socket-side core wire for sending or receiving said transmission signal to or from said device under test via said socket; and
a socket-side shield surrounding said socket-side core wire; and
a cable unit for transmitting said transmission signal between said socket and said pin electronics board,
wherein said cable unit comprises:
a board fitting connector fitted with said board-side connector;
a socket fitting connector fitted with said socket-side connector; and
a transmission cable for transmitting said transmission signal between said board fitting connector and said socket fitting connector, and
said transmission cable comprises:
a transmission line for transmitting said transmission signal between said board-side core wire and said socket-side core wire by electrically coupling said board-side core wire and said socket-side core wire; and
a cable shield electrically coupled to said board-side shield and said socket-side shield and surrounding said transmission line.

2. A device interface apparatus as claimed in claim 1, wherein
said board-side connector comprises:
a plurality of said board-side core wires; and
said board-side shield surrounding each of said plurality of board-side core wires,
said socket contacts each of said terminals of said device under test and holds said device under test;
said socket-side connector comprises:
a plurality of said socket-side core wires; and
said socket-side shield surrounding each of said plurality of socket-side core wires, and
said cable unit comprises a plurality of said transmission cables.

3. A device interface apparatus as claimed in claim 2 further comprising a connector holding unit for holding said socket fitting connector on a predetermined position, so that said socket fitting connector faces said socket,
wherein said socket-side connector is fitted with said socket fitting connector on said predetermined position.

4. A device interface apparatus as claimed in claim 3 further comprising:
a motherboard unit comprising said cable unit and said connector holding unit; and
a detachable unit comprising said socket and said socket-side connector, wherein said detachable unit can be mechanically attached or detached to or from said motherboard unit according to whether said socket-side connector and said socket fitting connector are fitted with each other or not.

5. A device interface apparatus as claimed in claim 4, wherein said detachable unit is formed corresponding to a product type of said device under test and attached to said motherboard unit when said device under test of a corresponding product type is tested.

6. A device interface apparatus as claimed in claim 4 further comprising a test head comprising said pin electronics board and said board-side connector,
wherein said motherboard unit can be mechanically attached or detached to or from said test head according to whether said board-side connector and said board fitting connector are fitted with each other or not.

7. A device interface apparatus as claimed in claim 2, wherein
said board-side connector comprises a plurality of said board-side shields respectively surrounding each of said plurality of board-side core wires and electrically independent from one another in said board-side connector, and
said cable shields of said plurality of transmission cables are independent from one another between said board fitting connector and said socket fitting connector and respectively electrically coupled to each of said plurality of board-side shields.

8. A device interface apparatus as claimed in claim 7, wherein said board fitting connector comprises:
a plurality of transmission core wires respectively coupled to each of said transmission lines of said plurality of transmission cables; and
a plurality of transmission shields respectively surrounding each of said plurality of transmission core wires, electrically independent from one another in said board fitting connector, and respectively coupling each of said plurality of cable shields and each of said plurality of board-side shields.

9. A device interface apparatus as claimed in claim 7, wherein
said pin electronics board comprises:
a signal wire for transmitting said transmission signal; and
a plurality of ground wires which are grounded,
said board-side core wire formed of a conductor extends linearly,
said board-side shield is formed of a conductor electrically insulated from said board-side core wire, extending in an axis direction of said board-side core wire and surrounding said board-side core wire, and said board-side connector further comprises:
a signal electrode extending from said board-side core wire and electrically coupling said board-side core wire and said signal wire; and
a plurality of ground electrodes extending from said board-side shield, facing each other with said signal electrode interposed, and coupling said board-side shield and each of said plurality of ground wires.

10. A device interface apparatus as claimed in claim 2, wherein
said socket-side connector comprises a plurality of said socket-side shields respectively surrounding each of said plurality of socket-side core wires and electrically independent from one another in said socket-side connector, and
said cable shields of said plurality of transmission cables are electrically independent from one another between said board fitting connector and said socket fitting connector and respectively electrically coupled to each of said plurality of socket-side shields.

11. A device interface apparatus as claimed in claim 10, wherein said socket fitting connector comprises:
a plurality of transmission core wires respectively coupled to said transmission line of each of said plurality of transmission cables; and
a plurality of transmission shields respectively surrounding each of said plurality of transmission core wires, electrically independent from one another in said socket fitting connector, and respectively coupling each of said plurality of cable shields and each of said plurality of socket-side shields.

12. A device interface apparatus as claimed in claim 10, wherein
said socket comprises:
a signal wire for transmitting said transmission signal; and
a plurality of ground wires which are grounded,
said socket-side core wire formed of a conductor extends linearly,
said socket-side shield is formed of a conductor electrically insulated from said socket-side core wire, extending in an axis direction of said socket-side core wire and surrounding said socket-side core wire, and
said socket-side connector further comprises:
a signal electrode extending from said socket-side core wire and electrically coupling said socket-side core wire and said signal wire; and
a plurality of ground electrodes extending from said socket-side shield, facing each other with said signal electrode interposed, and coupling said socket-side shield and each of said plurality of ground wires.

13. A device interface apparatus as claimed in claim 1, wherein
said board fitting connector comprises:
a transmission core wire coupled to said transmission line of said transmission cable; and
a transmission shield surrounding said transmission core wire in said socket fitting connector and coupling said cable shield and said board-side shield, and
said board-side shield contacts said transmission shield before said board-side core wire is coupled to said transmission core wire, when said board-side connector and said board fitting connector are coupled to each other.

14. A device interface apparatus as claimed in claim 1, wherein
said socket fitting connector comprises:
a transmission core wire coupled to said transmission line of said transmission cable; and
a transmission shield surrounding said transmission core wire in said socket fitting connector and coupling said cable shield and said board-side shield, and
said socket-side shield contacts said transmission shield before said board-side core wire is coupled to said transmission core wire, when said socket-side connector and said socket fitting connector are coupled to each other.
